(19) United States
(12) Patent Application Publication
(10) Pub. No.: US 2012/0060829 A1
(43) Pub. Date: Mar. 15, 2012

(54) ENERGY MANAGEMENT SYSTEM WITH SOLAR WATER HEATER

(75) Inventors: Samuel Vincent DuPlessis, Louisville, KY (US); John Joseph Roetker, Louisville, KY (US)

(73) Assignee: General Electric Company, Schenectady, NY (US)

(21) Appl. No.: 13/046,870

(22) Filed: Mar. 14, 2011

(51) Int. Cl. F24H 9/20; F24H 1/18; H05B 1/02; F24J 2/42

(52) U.S. Cl. 126/609; 126/615; 219/490; 392/308

(57) ABSTRACT

A water heater system is provided with a solar water heater and an electric water heater having one or more electric heating elements. The solar and electric water heaters are configured to provide a common hot water output. A controller is operatively configured with the water heaters and receives a first signal indicative of a current power demand state of an associated electric utility. In response to the received signal, the controller operates the electric water heater in an energy savings mode during periods of high power demand wherein power consumption of the electric heating elements is restricted. The controller is operatively configured to modulate the degree of power consumption restriction placed on the electric heating elements in the energy savings mode as a function of current hot water supply capacity of the solar water heater.

### FIELD OF THE INVENTION

The present subject matter relates generally to energy management of electrical appliances and other electrical power consuming devices and more particularly to energy management in an electrical system that includes of a solar water heater.

### BACKGROUND OF THE INVENTION

Electrical utility companies generally charge a flat rate. However, with increasing fuel prices and high energy usage at certain parts of the day, utilities have to buy more energy to supply customers during peak demand and, consequently, are charging higher rates during peak demand. If peak demand can be lowered, then a potential huge cost savings can be achieved and the peak load that the utility has to accommodate is lessened. In this regard, there is a high interest in energy management systems that control or regulate the power consuming features of various household appliances as a function of various energy supply factors, such as energy need and availability, demand states, appliance priorities, consumption rate, and so forth. Reference is made, for example, to U.S. Patent Publication No. 2010/0211233 and U.S. Patent Publication No. 2010/0175719.

U.S. Patent Publication No. 2010/0187219 describes an energy management system wherein a controller is connected the power consuming features of the water heater, including electrical heating elements. The controller is, in turn, configured to receive and process signals indicative of a utility state, and to operate the water heater in one of a plurality of different modes, including a power-saving mode, in response to the signals. The controller selectively adjusts or deactivates the power consuming features to reduce power consumption of the heater in the energy savings mode.

Passive and active solar water heaters are known in the art. The passive systems rely on convection or heat pipes to circulate water or a heat transfer fluid through the system. The active systems use a pump to circulate the water (direct system) or heat transfer fluid (indirect system) between a solar collector and a storage tank. With the indirect system, a heat exchanger in the tank heats water supplied to the tank, for example from the building's water supply system. Modern active solar water heaters are typically provided with an electronic, programmable controller that provides various functions, including pump control to prevent overheating of the water in the storage tank or freezing of the water in the collector, thermostatic and time-clock control of auxiliary electric or gas heaters, and so forth.

There are, however, inherent disadvantages to solar water heaters. They are generally inefficient at supplying water at a hot enough temperature or volume during periods of peak demand and in low sunlight conditions, for example during a period of multiple morning or evening showers in a large household. For this reason, solar water heating systems typically incorporate an electric or gas back-up heater.

Although solar water heating systems offer distinct energy savings, it would still be desirable to reduce the energy consumption of these systems, particularly during peak demand times.

### BRIEF DESCRIPTION OF THE INVENTION

Aspects and advantages of the invention will be set forth in part in the following description, or may be obvious from the description, or may be learned through practice of the invention.

In an exemplary embodiment, a water heater system is provided having a solar water heater and an electric water heater with one or more electric heating elements. The solar and electric water heaters are configured to provide a common hot water output. A controller is operatively configured with the solar and electric water heaters and receives a first signal indicative of a current power demand state of an associated electric utility. In response to the received signal, the controller operates the electric water heater in an energy savings mode during periods of high power demand wherein power consumption of the electric heating elements is restricted. The controller is further configured to modulate the degree of power consumption restriction placed on the electric heating elements in the energy savings mode as a function of current hot water supply capacity of the solar water heater.

In a particular embodiment, the system includes a common water storage tank, with the solar water heater utilizing a heat exchanger disposed within the common storage tank. The electric heating elements are also disposed within the common storage tank. In an alternate embodiment, the solar and electric water heaters comprise individual respective storage tanks.

The controller may be configured to receive a second signal indicative of the actual hot water capacity of the solar water heater during the periods of high power demand. For example, a sunlight sensor (e.g., a photovoltaic sensor) may be configured to provide this second signal, wherein the degree of power consumption restriction on the electric heating elements in the energy savings mode is modulated as a function of the presence or intensity of sunlight. In an alternate embodiment, the solar water heater may include a water storage tank and associated temperature sensor configured to provide the second signal, wherein the degree of power consumption restriction placed on the electric heating elements in the energy savings mode is modulated as a function of temperature of the water in the storage tank. In still a further embodiment, the second signal may be an indication of the operating state of a heat transfer fluid pump in the solar water heater.

With still different embodiments of the water heater system, the controller is configured to modulate the degree of power consumption restriction on the electric heating elements as a function of predicted or calculated hot water capacity of the solar water heater. For example, the predicted hot water capacity may be based on empirical hot water usage data, or empirical sunlight conditions based on meteorological data.

During non-energy savings modes, the controller may be configured to control the electric water heater to supplement the common hot water output of the system without restriction on power consumption of said electric heating elements, with the electric water heater being a supplemental supply to the primary solar water heater supply.

The present invention also encompasses various control method embodiments for operating a water heater system wherein a solar water heater and an electric water heater provide a common hot water output. The method includes detecting a current power demand state of an electric utility that supplies power to the electric water heater and, during periods of high power demand, operating the electric water heater in an energy savings mode wherein power consumption of the electric water heater is restricted as compared to non-high power demand periods. During the periods of high power demand, the current capacity of the solar water heater to supply hot water is determined and the degree of power consumption restriction placed on the electric water heater in the energy savings mode is modulated as a function of the capacity of the solar water heater.

The current capacity of the solar water heater may be determined based on a measured or detected parameter, such as the actual sunlight condition, temperature of the water in the solar water heater storage tank, or operational state of the heat transfer fluid pump. In alternate embodiments, the capacity of the solar water heater may be determined based on empirical data, such as historical data of hot water usage during the periods of high power demand or empirical data related to sunlight conditions.

In non-energy savings modes, the electric water heater may be controlled to supplement the common hot water output of the system without restriction on the power consumption of the electric water heater. The electric water heater may be maintained as a supplemental source of hot water to the primary solar water heater during these times.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is diagram view of an embodiment of a water heater system in accordance with aspects of the invention;

FIG. 2 is a diagram view of an alternative embodiment of a water heater system; and

FIG. 3 is a flow diagram of operation of an embodiment of a water heater system in accordance with aspects of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As discussed in greater detail below, embodiments of the present invention relate to a water heater system configured to supply hot water to a building or other structure, such as a residential structure. Reducing total energy consumed by the home or structure encompasses reducing the energy consumed at peak times and/or reducing the overall electricity demands. Electricity demands can be defined as average watts over a short period of time, typically 5-60 minutes. Off peak demand periods correspond to periods during which lower cost energy is being supplied by the utility relative to peak demand periods. In accordance with aspects of the present invention, the water heater system is in communication with the utility provider that supplies the power and the system is managed such that, in response to a signal indicative of a high or peak power condition, the water heater system is switched to an energy savings mode. Power restrictions placed on water heater system in the energy savings mode are modulated based on the capacity of an integrated solar water heater.

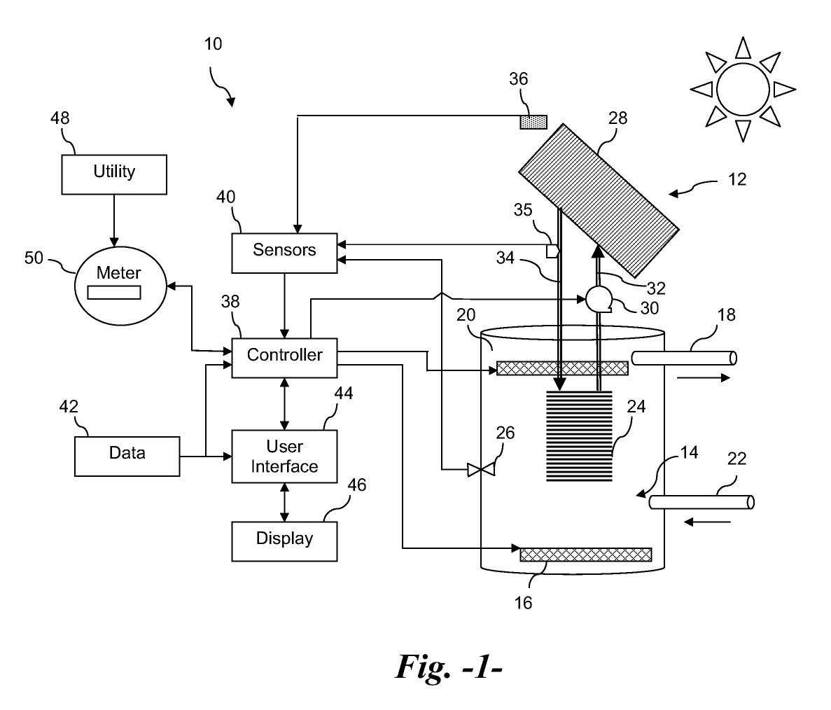

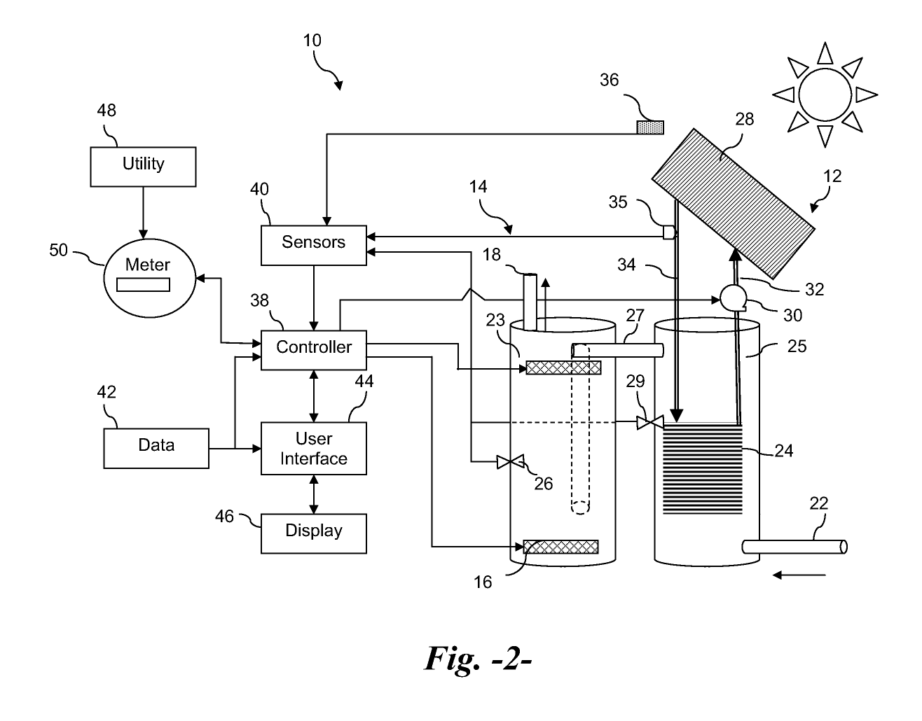

FIGS. 1 and 2 depict exemplary embodiments of a managed water heater system 10 that includes a solar water heater 12 and an electric water heater 14. The two systems 12, 14 are integrated to provide a common hot water output 18 to a building or other structure. In the illustrated embodiment of FIG. 1, the system 10 includes a common storage tank 20, which may be any suitable insulted tank configured for storage of water within a desired heated temperature range. The tank 20 is supplied with unheated (e.g., cold) water through an input 22, which is heated by the solar and/or electric water heaters 12, 14, as described in greater detail below.

The solar water heater 12 may be a passive or active system, and may be a direct or indirect heat transfer system. The invention is not limited to any particular configuration of the solar water heater 12. In the illustrated embodiment, the solar water heater 12 is an active indirect system wherein a heat transfer fluid (HTF), which is typically a glycol-water mixture, is circulated by a pump 30 between a solar collector 28 and a heat exchanger 24 located within the storage tank 20. The solar collector 28 may be any type or combination of known available solar collectors, including flat plate collectors, evacuated tube collectors, formed collectors, and ICS (Integrated Collector Storage) systems. The solar collector 28 is suitably located on the building or other structure to capture and transform the sun's energy into heat to heat the HTF, which then transfers its heat to the water within the storage tank 20 via any type of fluid-flow heat exchanger, for example a coiled tube heat exchanger. The water storage tank 20 can be encased by an insulative housing or wrapper, whereby an inner surface of the housing and an outer surface of the water tank 20 together define an insulation volume that serves to insulate the tank 20 from the external environment. The function and operation of conventional solar water heaters 12 is well known and need not be described in greater detail herein.

In the illustrated embodiment of FIG. 1, the electric water heater 14 includes one or more electric resistive heating elements 16 located within the storage tank 20. For example, one element 16 may be located in the top portion of the storage tank 20 with another element 16 is located in the bottom portion of the tank 20, as depicted in the figures. The elements 16 are generally cycled on and off under thermostatic control to maintain the water within the storage tank 20 within a desired temperature band, as in well know in the art.

In FIG. 1, the electric water heater 14 and solar water heater 12 share a common storage tank 20 and, in a normal operating mode, the electric heating elements 16 may be energized to provide a supplement heat source when the solar water heater 12 is unable to maintain the temperature of the water within the tank 20 within a setpoint band, for example at night or during periods of low sunlight. In the embodiment of FIG. 2, the electric water heater 14 has a dedicated storage tank 23 and the solar water heater 12 has a dedicated storage tank 25. In this embodiment, the tanks 23, 25 are configured in series, with cold water in introduced into the tank 25 via the inlet 22, heated by the solar water heater 12, and then introduced into the storage tank 23 via the line 27. The solar water heater 12 thus pre-heats the water introduced into the storage tank 23 and the electric heating elements 16 need only be energized if needed to maintain the water in the tank 23 within the setpoint temperature band. A recirculation line (not illustrated) may be configured between the two tanks 23, 25. It should be readily appreciated that, in an alternate embodiment, the heaters 12, 14 may have individual respective storage tanks 25, 23 that are configured in parallel to provide a common hot water output 18.

The water system 10 includes a controller 38 operably configured with the electric water heater 14 and solar water heater 12 to control various functions of the heaters. In a particular embodiment, the controller 382 may include a micro computer on a printed circuit board which is programmed to selectively control the energy consumption of the power consuming features/functions of the system. The controller 38 is configured to receive and process a signal from the utility provider 48 (e.g. an electric power company) that is indicative of the current power demand state of the utility, for example, availability and/or current cost of supplied energy. The energy signal may be generated by the utility provider 48 and transmitted via a power line, as a radio frequency signal, or by any other means for transmitting a signal as to when the utility provider 48 desires to reduce demand for its resources. The cost can be indicative of the state of the demand for the utility's energy, for example a relatively high price or cost of supplied energy is typically associated with a high or peak demand state or period and a relative low price or cost is typically associated with an off-peak demand state or period.

The controller 38 may also derive the energy signal from a utility meter 50, which can indicate the occurrences of peak demand and demand limits. For example, the home owner can choose to force various operating modes on the water heater system 10 based on the rate the utility provider 48 is charging at different times of the day and demand limits set by the home owner or the utility provider 48. The controller 38 will analyze the energy consumption currently used by the home via the meter 50 and determine if the home is exceeding the demand limits. If the demand limits are exceeded, the controller 38 will switch operation of the water heater system 10 (and other appliances) into an energy savings mode.

Thus, operation of the water heater system 10 may vary as a function of a characteristic of the utility state and/or supplied energy, e.g., availability and/or price. Because some energy suppliers offer what is known as time-of-day pricing in their tariffs, price points could be tied directly to the tariff structure for the energy supplier. If real time pricing is offered by the energy supplier serving the site, this variance could be utilized to generate savings and reduce chain demand. Another load management program offered by energy supplier utilizes price tiers which the utility manages dynamically to reflect the total cost of energy delivery to its customers. These tiers provide the customer a relative indicator of the price of energy and are usually defined as being LOW, MEDIUM, HIGH and CRITICAL. The controller 38 is configured to operate the water heater system 10 in an operating mode corresponding to one of the price tiers. For example, the controller may be configured to operate the water heater system 10 in the normal operating mode during each of the low and medium price tiers, and to operate the water heater system 10 in the energy savings mode during each of the high and critical price tiers. However, it will be appreciated that the controller 38 could be configured to implement a unique operating mode for each tier which provides a desired balance between compromised performance and cost savings/energy savings. If the utility offers more than two rate/cost conditions, different combinations of energy saving control steps may be programmed to provide satisfactory cost savings/performance tradeoff.

The controller 38 can thus operate the water heater system 10 in one of a plurality of operating modes, including a normal operating mode and an energy savings mode, in response to the received energy signal. Specifically, the water heater system 10 can be operated in the normal mode in response to a signal indicating an off-peak demand state or period, and can be operated in an energy savings mode in response to an energy signal indicating a peak or high demand state. As will be discussed in greater detail below, the controller 38 is configured to selectively delay, adjust, or disable any combination of power consuming features/functions, in particular the electric heating elements 16, to reduce power consumption of the water heater system 10 in the energy savings mode. It should be appreciated that the controller 38 can be configured with default settings which govern normal mode and energy savings mode operation. Such settings in each mode can be fixed while others adjustable to user preference and to provide response to load shedding signals.

In the normal operating mode, the temperature of the water in the common storage tank 20 (FIG. 1) or electric water heater storage tank 23 (FIG. 2) is sensed by a temperature sensor 26 and input to the controller 38 as one of the sensor inputs 40. The controller 38 energizes the electric heating elements 16 as needed in a thermostatic control loop to maintain the water at a desired setpoint temperature (which includes a temperature range). The solar water heater 12 may operate continuously or intermittently to contribute heating energy to the water within the tank 20, 23. The temperature of the HTF may be supplied to the controller 38 from a temperature sensor 35, and the controller may control operation of the pump 30 to prevent overheating, freezing, or other detrimental conditions with respect to the solar collector 28.

A control panel or user interface 44 is provided with the water heater system 10 and is operatively connected to the controller 38. The interface 44 may include a display 46 and control buttons for making various operational selections, such as setting the desired setpoint temperature of the water, demand limits, overrides, or any other control function.

If the controller 38 receives and processes an energy signal indicative of a high demand period at any time during operation of the water heater system 10, the controller makes a determination of whether one or more of the power consuming features/functions of the system 10 should be operated in the energy savings mode and if so, it signals the appropriate features/functions to begin operating in the energy savings mode in order to reduce the instantaneous amount of energy being consumed by the water heater system 10. For example, as set forth above, the water heater system 10 has a setpoint temperature in the normal operating mode. To reduce the power consumption of the system 10 in the energy savings mode, the controller 38 may be configured to reduce the setpoint temperature of the water heater to precipitate less on time of the heating elements 16 in the energy savings mode. To further reduce the power consumption, the controller 38 may be configured to reduce power of at least one of the heating elements 16 in the energy savings mode regardless of the setpoint temperature. For example, the controller can deactivate, reduce voltage to and duty cycle of one or both of the heating elements 16 in the energy savings mode.

According to particular aspects of the invention, the controller 38 is further configured to modulate the degree of power consumption restriction placed on the heating elements 16 in the energy savings mode as a function of the capacity of the solar water heater 12 at that particular time. Hot water is considered by many to be a basic necessity, or a quasi-luxury that some are just not willing to go without. An energy management system that completely or substantially deprives consumers with hot water during peak power times may not be readily accepted by many consumers, particularly when the peak power times coincide with early morning or evening shower/bath times. An energy management system that is not appreciated or accepted will generally not be utilized by consumers. To address this issue, the controller 38 will “consider” the capacity of the solar water heater 12 to supply hot water during the energy savings mode and modulate the electrical restrictions placed on the heating elements 16 accordingly. For example, the greater the capacity of the solar water heater 12, the greater will be the electrical restrictions placed on the heating elements 16. Likewise, if the solar water heater 12 has little or no capacity to deliver hot water at a certain temperature, the restrictions (reductions) placed on the heating elements 16 may be minimal, or none at all.

The controller may determine the capacity of the solar water heater 12 in various ways. In particular embodiments, the actual hot water capacity of the solar water heater 12 may be measured or derived from signals that are indicative of the operational state of the system. For example, a sunlight sensor 36 may be located to detect the actual light conditions at the solar collector 28. This sensor 36 may be, for example, a photo-voltaic cell that produces an electrical signal (e.g., voltage) that is proportional to the amount of sunlight incident on the cell. This signal may be used by the controller 38 to determine the capacity of the solar water heater 12 and modulate the restrictions placed on the heating elements 16 proportionately.

Referring to FIG. 2, in an alternate embodiment, the controller may receive a signal from a temperature sensor 29 that detects the actual temperature of the water within the solar water heater storage tank 25 if the tank 25 is not in a recirculation configuration with the electric water heater storage tank 23. This temperature signal, along with the known volume of water within the tank 25 enables the controller 38 to determine the capacity of the solar water heater 12 to supplement the hot water withdrawn from the tank 23 during the energy savings mode of operation. As the hot water in the tank 25 is depleted (as detected by temperature sensors 26, 29) the restrictions on the heating elements 16 may be reduced so that the consumer does not experience an appreciable difference in their hot water supply.

In still a further embodiment, the signal received by the controller 38 indicative of the actual capacity of the solar water heater system 12 may be provided by a temperature sensor 35 configured to detect the temperature of the HTF in the outlet line 34 to the heat exchanger 24. This signal is indicative of the actual operating state of the collector 28 regardless of the amount of light detected by the sensor 36.

In still a further embodiment, the solar water heater system 12 is controlled such that the pump 30 only operates when the system is capable of producing hot water, for example as determined by the temperature of the HTF sensed by temperature sensor 35. The controller 38 may simply detect operation of the pump 30 as an indication of the actual capacity of the solar water heater system to produce hot water. During an energy savings mode, the controller 38 may simply disable the electric heating elements 16 if it detects that the pump 30 is running. This embodiment may be desired in that it eliminates the need for various sensor inputs as discussed above.

It should be appreciated that the controller 38 is not limited to any one particular sensor input for determining the capacity of the solar water heater 12. Any combination of the sensor inputs or pump operating signal discussed above may be inputs to a weighted control algorithm for modulating the restrictions placed on the electric heating elements 16.

In still other embodiments, the controller 38 may modulate the restrictions placed on the heating elements 26 based a predicted capacity of the solar water heater 12. For example, the controller 38 may be provided with data 42 that reflects actual or empirically derived historical hot water usage during high demand periods. This data may be used to predict the amount of hot water the system 10 will need to generate during the current high demand period and to what degree the solar water heater 12 can meet such demand. This water usage data may be periodically updated by the consumer (or even the utility 48) to reflect changing water usage patterns, particularly during the different seasons.

Similarly, the controller 38 may use actual or empirically derived historical data of sunlight conditions to aid in predicting the capacity of the solar water heater 12. A region having few average days of sunlight during a particular season will not have the solar water heater capacity of a system in an arid desert region, and the controller may use this information to predict the capacity of the solar water heater 12 and degree of modulation placed on the heating elements 16.

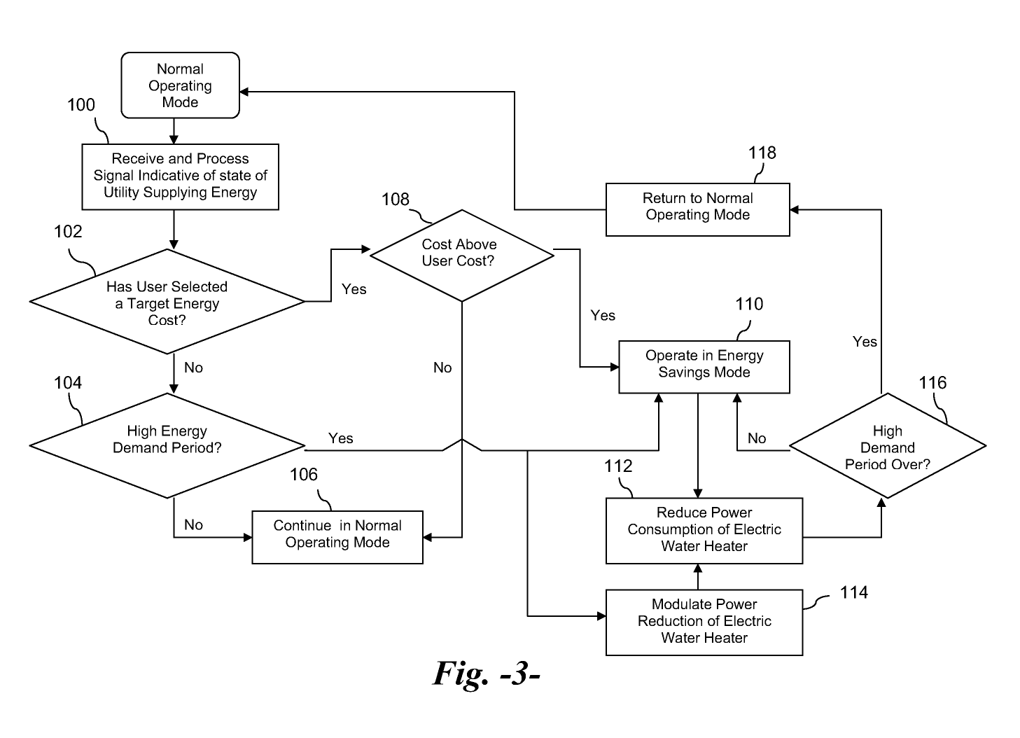

The present invention also encompasses various control methodologies for operating a water heater system 10 wherein a solar water heater and an electric water heater provide a common hot water output. Referring to FIG. 3, one embodiment of a control method is depicted wherein the system is initially in a normal operating mode. At step 100, a signal indicative of the state of the power demand state of the utility company is received, such as a cost of supplying the energy. At step 102, the user can base operation of the water heater system 10 on a user selected targeted energy cost, such as a selected pricing tier or cost per kilowatt hour charged by the corresponding utility. If the current cost exceeds the selected cost at step 108, the controller 38 will operate the water heater system 10 in the energy savings mode at step 110. If the current cost is less than the selected cost, the controller 38 will operate the water heater system 10 in the normal mode at step 106. This operation based on a user selected targeted energy cost may be reflective of peak and off-peak demand periods placed on the utility company, but need not be. The user may simply set their target cost thresholds, which are compared to actual costs regardless of whether or not the utility is in a peak demand period.

The process of FIG. 3 may also include consideration of peak (high) demand periods. For example, if the user has not set a target cost at step 102, then at step 104, determination is made as to whether the system 10 is operating in a peak demand period. If not, the system 10 continues to operate in normal mode at step 106. If the peak demand period is determined, then the system is switched to energy savings mode at step 110 and power consumption restrictions are placed on the electric water heating elements 16 at step 112. Simultaneously, at step 1114, the capacity of the solar water heater 12 is determined and used to modulate the restrictions place on the heating elements, as discussed above. The power demand state is monitored at step 116, and when the period is over, the system 10 is once again returned to the normal operating mode at step 118.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater system, comprising:
a solar water heater;
an electric water heater having one or more electric heating elements;
said solar and electric water heaters configured to provide a common hot water output;
a controller operatively configured with said solar and electric water heaters, said controller configured to receive a first signal indicative of a current power demand state of an associated electric utility and, in response to the received signal, to operate said electric water heater in an energy savings mode during periods of high power demand wherein power consumption of the electric heating elements is restricted; and
said controller operatively configured to modulate the degree of power consumption restriction on said electric heating elements in the energy savings mode as a function of current hot water supply capacity of said solar water heater.

2. The water heater system as in claim 1, further comprising a common water storage tank, said solar water heater comprising a heat exchanger disposed within said common storage tank, and said electric heating elements disposed within said common storage tank.

3. The water heater system as in claim 1, wherein said solar and electric water heaters comprise individual respective storage tanks.

4. The water heater system as in claim 1, wherein said controller is configured to receive a second signal indicative of actual hot water capacity of said solar water heater.

5. The water heater system as in claim 4, further comprising a sunlight sensor configured to provide said second signal, wherein the degree of power consumption restriction on said electric heating elements in the energy savings mode is modulated as a function of presence or intensity of sunlight.

6. The water heater system as in claim 4, wherein said solar water heater comprises a water storage tank and associated temperature sensor configured to provide said second signal, wherein the degree of power consumption restriction on said electric heating elements in the energy savings mode is modulated as a function of temperature of the water in said storage tank.

7. The water heater system as in claim 4, wherein said solar water heater comprises a heat transfer fluid pump, said second signal received by said controller indicating whether said pump is running as an indication of the actual hot water capacity of said solar water heater.

8. The water heater system as in claim 1, wherein said controller is configured to modulate the degree of restriction of power consumption on said electric heating elements as a function of predicted hot water capacity of said solar water heater.

9. The water heater system as in claim 8, wherein the predicted hot water capacity is based on empirical hot water usage data.

10. The water heater system as in claim 8, wherein the predicted hot water capacity is based on empirical sunlight conditions.

11. The water heater system as in claim 1, wherein in non-energy savings modes, said controller is configured to control said electric water heater to supplement the common hot water output of said system without restriction on power consumption of said electric heating elements.

12. A control method for operating a water heater system wherein a solar water heater and an electric water heater provide a common hot water output, the method comprising:
detecting a current power demand state of an electric utility that supplies power to the electric water heater;
during periods of high power demand, operating the electric water heater in an energy savings mode wherein power consumption of the electric water heater is restricted as compared to non-high power demand periods;
during the periods of high power demand, determining current hot water supply capacity of the solar water heater; and
modulating the degree of power consumption restriction placed on said electric water heater in the energy savings mode as a function of the current hot water supply capacity of the solar water heater.

13. The method as in claim 12, wherein the current hot water supply capacity of the solar water heater is determined based on a measured or detected parameter.

14. The method as in claim 13, wherein the parameter is an actual sunlight condition.

15. The method as in claim 13, wherein the solar water heater has a water storage tank and the parameter is temperature of the water in the storage tank.

16. The method as in claim 13, wherein the parameter is detection of the operating state of a heat transfer fluid pump in the solar water heater.

17. The method as in claim 12, wherein the current hot water supply capacity of the solar water heater is determined based on empirical data.

18. The method as in claim 17, wherein the empirical data is empirical hot water usage during the periods of high power demand.

19. The method as in claim 17, wherein the empirical data is empirical sunlight conditions during the periods of high power demand.

20. The method as in claim 12, wherein in non-energy savings modes, the electric water heater is controlled to supplement the common hot water output of the system without restriction on power consumption of the electric water heater.
